(19) United States
(12) Patent Application Publication
(10) Pub. No.: US 2026/0235491 A1
(43) Pub. Date: Aug. 13, 2026

(54) MULTI-WELL ASSAY PLATE SYSTEM FOR ENHANCED FLOW CYTOMETRY AND METHOD OF USE

(71) Applicant: Azure Biosystems Inc., Dublin, CA (US)

(72) Inventors: Catalin Pavel, Madrid (ES); You Chen, Pleasanton, CA (US); Wei Xu, Montreal (CA); Lilian Sirbu, Mascouche (CA); Lipo Xu, Beijing (CN)

(21) Appl. No.: 19/533,517

(22) Filed: Feb. 9, 2026

Related U.S. Application Data
(60) Provisional application No. 63/755,897, filed on Feb. 7, 2025.

(51) Int. Cl. G01N 15/1429; G01N 35/00; G01N 35/02; G01N 35/10

(52) U.S. Cl. CPC G01N 15/1431; G01N 35/00693; G01N 35/00732; G01N 35/028; G01N 35/1002; G01N 35/1004; G01N 2035/00455; G01N 35/00663

(57) ABSTRACT

The present disclosure provides flow cytometers, reagent cartridges, multi-well reagent and sample plates, and methods of analyzing a sample by flow cytometry using same.

### FIELD OF THE INVENTION

This invention relates to the field of biotechnology and laboratory equipment, specifically an improved multi-well assay plate system designed for use in flow cytometry.

### BACKGROUND OF THE INVENTION

The traditional landscape of flow cytometry has been challenged by limitations such as the bulkiness of equipment, complex operational requirements, and high maintenance costs. These constraints have restricted flow cytometry's broader application and adaptability, especially in varied research and field environments.

Multi-well assay plates are fundamental tools in biological and medical research, offering a means to process multiple samples simultaneously or conduct various assays. Traditional assay plates require extensive manual preparation, including the labor-intensive addition of reagents and buffers. This manual process is prone to errors and inconsistencies, which can compromise data quality. Furthermore, the adaptability of these plates to diverse assay types has been limited, often requiring separate plates and preparation protocols for different assays.

Advancements in assay technology have led to the development of automated systems and preloaded reagents aimed at reducing manual labor and increasing throughput. However, these systems often lack flexibility and are not universally adaptable to a wide range of assay types. Additionally, the management of assay information and traceability remains a challenge, with most systems relying on manual record-keeping.

### SUMMARY OF THE INVENTION

Another object of the invention is to overcome the drawbacks of state-of-the art flow cytometers That often face challenges such as limited adaptability to diverse assay requirements, a dependency on specific fluidics components that can constrain design flexibility, and the need for complex calibration protocols that increase operational overhead. This application introduces a streamlined, adaptable multi-well assay plate system that simplifies workflows, reduces calibration dependencies, and improves the integration of sample preparation and analysis.

A multi-well assay plate system for flow cytometry is provided, comprising a sample preparation module, a handler wash module, a sample analyzer and a processing unit. The sample preparation module incorporates a tray designed to accommodate at least one tube containing sample specimen and a multi-well assay plate which is configured to complete an assay for the sample specimen. The sample preparation module also incorporates a reader and a liquid handler which includes at least one probe transporting fluids among said tube, said assay plate and said handler wash module. The probe also connects with the sample analyzer which performs an analysis of prepared sample in the sample preparation module. The processing unit coordinates the operation of the sample preparation module, the handler wash module, and the sample analyzer in the system. A label providing information about an assay type that the assay plate can be used is presented on the assay plate. The label provides information about said assay type with a link to an assay protocol. Optionally, one or more reagent tubes are utilized in conjunction with the assay plate to complete the assay.

The tray is also designed to accommodate a cartridge that contains at least a clean solution, disinfection solution, surfactant solution, and calibration beads suspension. Optionally, a CCD camera, which is slightly adjustable in the vertical direction, is mounted in the header of the liquid handler.

Advanced CO₂ regulation and humidity control systems are integrated into the sample preparation module. Furthermore, a temperature control system is also equipped in the sample preparation module.

A method of preparing a sample specimen, analyzing the prepared sample specimen and outputting the analysis results using a multi-well assay plate system is provided. The method comprises: receive one tube containing sample specimen, scan label on the tube, receive tube location and volume of sample specimen, receive a multi-well assay plate, scan label on the assay plate, load the assay protocol to software or computing unit, determine if the volume of sample specimen is enough to complete the assay protocol, run the loaded assay protocol to prepare the sample specimen if the volume is enough, load the prepared sample specimen to sample analyzer; automatically perform the data analysis and output the analysis result on the user interface.

Optionally, the system determines if additional reagents are required following the step that the assay protocol is loaded in the software/computing unit. If separate reagents are needed, the method also includes the steps below: receive at least one additional reagent tube including an additional reagent required to perform the desired assay, scan the label on the additional reagent tube(s), and receive a location associated with each additional reagent tube.

A method of preparing the multi-well assay plate system for assay with a cartridge is provided. The method includes the steps below: receive a cartridge; scan the label on the cartridge; load the preparation procedure to the software/computing unit; purge the system with cleaning solution; prime the system with sheath fluid from the sheath tank of the system; run said surfactant solution through the tubing of the system; debubble the solution from the sample tube; run calibration bead suspension through the system; adjust settings for the system according to the calibrated results.

The multi-well assay plates offer a streamlined and efficient approach to assay workflows. The preloading reagents and buffers tailored to specific assay requirements substantially reduce the manual labor involved in the sample preparation process.

The system operates seamlessly, utilizing loaded assay protocols to prepare sample suspension. This automation enhances precision and consistency in sample preparation, minimizing human error. The system autonomously transports the prepared sample suspension to the analyzer for detection and analysis, expediting the process and enhancing overall efficiency.

The cartridge, which contains a clean solution, disinfection solution, surfactant solution and calibration beads suspension, offers a simple and straightforward method to maintain and prepare the instrument for assay. Upon selecting the preparation of the instrument, the system autonomously follows a predefined preparation procedure. The streamlined process eliminates the need for manual steps, making it more user-friendly for researchers across different skill levels.

In summary, this invention represents a significant leap in flow cytometry, offering an unparalleled combination of precision, efficiency, adaptability, and cost-effectiveness, thereby addressing the critical needs of modern biological research and diagnostics.

### BRIEF DESCRIPTION OF DRAWINGS

FIG. 1 shows a representative block diagram of an example flow cytometer consistent with one embodiment of the present disclosure.

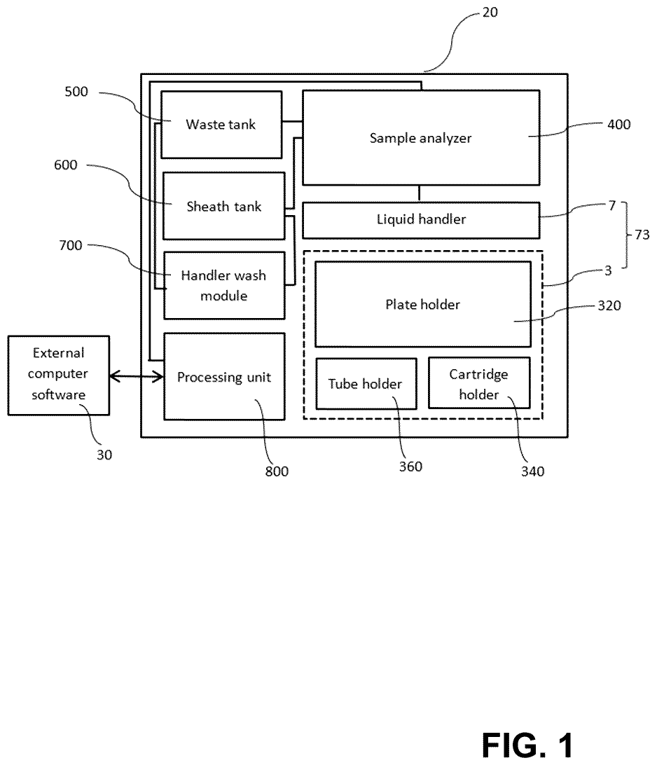

FIG. 2 shows a partial cross-sectional view of an example flow cytometer consistent with one embodiment of the present disclosure.

FIG. 3 schematically illustrates a portion of the fluidic system of an example flow cytometer consistent with one embodiment of the present disclosure.

FIG. 4 shows a representative block diagram of an example flow cytometer consistent with another embodiment of the present disclosure.

FIG. 5 is a flow chart illustrating a method of preparing a sample specimen, analyzing the prepared sample specimen, and outputting the analysis result using a multi-well assay plate system for flow cytometry consistent with one embodiment of the present disclosure.

FIG. 6 is a flow chart illustrating a method of preparing a sample specimen, analyzing the prepared sample specimen, and outputting the analysis result using a multi-well assay plate system consistent with another embodiment of the present disclosure.

FIG. 7 is a flow chart illustrating a method of preparing a multi-well assay plate system with a cartridge before performing a flow cytometry assay consistent with another embodiment of the present disclosure.

### DESCRIPTION OF SPECIFIC EMBODIMENTS OF THE INVENTION

### Assay Plate

A multi-well assay plate 4 is provided, comprising a plate body with a plurality of wells that are defined to include a plurality of sample wells which are used for sample processing, a plurality of reagent wells which are preloaded with reagents. In some embodiments, the sample wells are empty. In other embodiments, the sample wells are prefilled with buffers and/or reagents for performing a flow cytometry assay.

The assay plate 4 also includes a label with machine-readable code (e.g., bar code, QR code). The label provides information about the type of assay that the assay plate can be used for. Basic information, including manufacturer information, lot number, serial number of the assay plate, and expiration date, is also provided on the assay plate. A link to an assay protocol can also be provided with the assay type on the label.

The type of assay determines the specific reagents to be preloaded in the reagent wells. The reagents preloaded in the wells can be a single dye, a different dye mixture, or dyes mixed with buffer. Different assay types require distinct combinations of dyes and buffers. Depending on the storage requirements, the reagents can be dry or liquid. The volume of the reagents prefilled in the wells is also determined by the assay while ensuring that the volume of the reagents and samples mixture during the assay does not surpass the volume limitation of the wells.

In an advanced implementation, one or more reagents can be stored separately from the assay plate 4, such as in a tube or other containers. The separated reagent can be a dye if the dye requires a different storage environment from the other preloaded reagents in the assay plate. The separated reagent can be a buffer, if the sample wells are not prefilled with buffers or if the volume of the buffer preloaded in the sample wells is insufficient for the assay protocol. The separated containers are utilized in conjunction with the assay plate to conduct the assay successfully.

The assay plate 4 is covered by a puncturable foil seal to facilitate the sealing of each well. The puncturable foil seal isolates each well from the other wells, prevents contamination of each well's contents, and protects the preloaded reagents in the wells from degradation.

The multi-well assay plate 4 is meticulously designed to incorporate a sufficient number of sample wells and a sufficient volume of reagents preloaded in the reagent wells. The assay plate 4 is configured to meet the exact specifications of the assay, ensuring an ample and well-planned resource allocation to complete the experimental procedure successfully.

The multi-well assay plates 4 can have a variety of forms, sizes, and shapes. For convenience, the multi-well assay plates are typically made in standard sizes, shapes, and arrangements of wells. For example, the 96-well plates layout with a 12×8 array of wells.

Various example multi-well assay plates 4 are described in detail in Example 1 below.

### Flow Cytometer for Sample Preparation and Analysis

A flow cytometer 20 capable of sample preparation and analysis is provided. The flow cytometer 20 includes at least a waste tank 500, a sheath tank 600, a handler wash module 700, a processing unit 800, a sample analyzer 400, and a sample preparation module 73 including a tray 3 and a liquid handler 7.

The sample analyzer 400 performs an analysis of the prepared sample in the sample preparation module 73. The analyzer includes at least a flow cell 420, a laser system 430 and optical detectors 410 typically used in known flow cytometer configuration. The flow cell 420 includes optical fibers configured to transmit light (e.g., laser light) across the sample stream created by the flow cell 420, for example as described in U.S. Pat. No. 7,835,599, titled “flow cytometry analysis across optical fiber”, issued on Nov. 16, 2010, the entire contents of which are incorporated herein by reference and relied upon.

The sample preparation module 73 includes a liquid handler 7 in fluid communication with a tray 3 that includes at least a tube holder 360, a cartridge holder 340, a plate holder 320 configured to receive a multi-well assay plate 4.

In a preferred embodiment, the tray 3 can be moved horizontally, which enables users to easily place and retrieve tubes in the tube holder 360, assay plates 4 in the plate holder 320, and cartridges in the cartridge holder 340. In other embodiments wherein the tray 3 is not moveable horizontally, users can place and retrieve the tubes, assay plates and calibration cartridges through an openable panel of the instrument 20.

The tube holder 360 can hold one or more tubes 36. In a preferred embodiment, the tube holder 360 has four tube locations. The tube 36 can be a sample tube, or a separated reagent tube used in conjunction with an assay plate 4. At least one tube with sample suspension is placed by a user. The tubes 36 can be placed by a user. In some embodiments, the flow cytometer 20 further includes a rack configured to store a plurality of multi-well assay plates 4 and reagent tubes 36 that can be automatically loaded into the tube holder 360 and the plate holder 320 respectively, for example by a robotic arm (not shown).

The plate holder 320 is configured to receive a selected assay plate 4 for sample preparation. In some embodiments, the assay plate 4 is placed into the plate holder 320 by a user manually. In other embodiments, the flow cytometer 20 can select an assay plate 4 based on the sample information and automatically load it from the rack into the plate holder 320. In some embodiments, the plate holder 320 is configured to receive a standard 96-well plate having a 12×8 arrangement of wells.

The cartridge holder 340 is configured to hold a cartridge 2 configured to store solutions used for cleaning and maintenance, as well as beads suspension for calibrating the instrument. The cartridge is utilized for daily routine maintenance of the instrument and preparation of the instrument for assays.

In some embodiments, the cartridge contains at least four containers configured to separately store a clean solution, a disinfection solution, a surfactant solution and a calibration beads suspension. In some embodiments, the solutions and suspension are each in ready to use formats, and the volumes of each are sufficient to operate the flow cytometer for one day. In some embodiments, the cartridge also includes a machine-readable code (e.g., a bar code or QR code), for example on a label. The code provides information associated with the solutions/calibration beads suspension, including for example the lot number, the expiration date, and the stock volume of the calibration beads. In some embodiments, the code is also associated with instructions (e.g., software code) for operating the flow cytometer in order to prepare the instrument for performing an assay.

The liquid handler 7 includes at least one probe 6, which in some embodiments, can sense a liquid level in a well of the assay plate 4 and transport solutions among the cartridge 2, the tubes 36, the assay plate 4, and the handler wash module 700. The probe 6 is also connected to the sample analyzer's flow cell 420 through a tube. The probe 6 is managed by the processing unit 800 and is configured to precisely regulate both the volume and destination of the transferred solution. Additionally, after the sample suspension is prepared, the probe 6 is configured to inject the prepared sample suspension into the sample analyzer 400.

Anytime the probe 6 touches the sample specimen, the reagents, or any other solution, the header 8 is configured to move to the handler wash module 700 to wash the probe 6 in order to prevent contamination between samples analyzed in series.

In some embodiments, a CCD camera is mounted to the liquid handler's header 8, which is capable of moving to the desired location in the tray 3. The CCD camera's focus can be adjusted, for example by moving the CCD camera vertically relative to the tray 3. The processing unit 800 controls the CCD camera to capture the images of the wells, for example to monitor the progress of a reaction occurring within the wells.

The sample preparation module also includes a reader or a scanner configured to read the barcode or QR code or any other code labeled on the tubes 36, the assay plates 4, and the cartridges 34.

In some embodiments, the sample preparation module includes a temperature control system configured to provide and maintain an ambient environment at room temperature. In some embodiments, the sample preparation module includes a carbon dioxide regulation system and a humidity control system configured to provide and maintain a desired CO₂ concentration and a desired humidity level, respectively, for example for incubating a sample preparation.

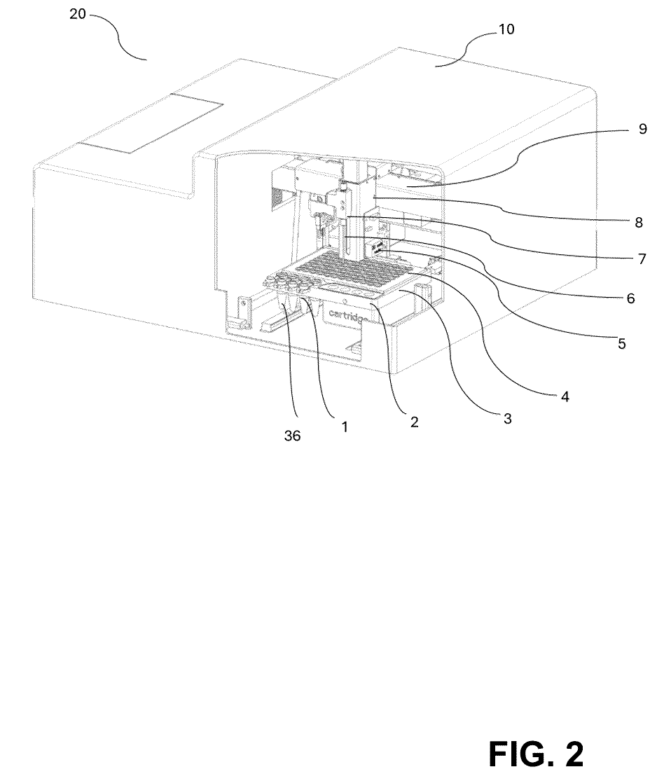

FIG. 2 depicts a detailed partial cross-sectional view of an example flow cytometer 20. Tray 3 is equipped with horizontal back-and-forth movement capabilities. Upon forward movement, it can extend from the outer shell 10 of the flow cytometer 20, allowing users to place sample tubes 1, reagent tubes 36, cartridges 2 and assay plates 4 as needed.

Liquid handler 7 including a probe 6 is mounted on the header 8. The liquid handler 7 is configured to move vertically on the header 8, which in some embodiments is associated with a stand frame 9 enabling the header 8 to move horizontally and laterally relative to the plate holder 320.

The horizontal and longitudinal movement of the tray 3, combined with the liquid handler 7's lateral and vertical mobility, allows the probe 6 to reach predetermined positions in sample tubes 1, reagent tubes 36, cartridges 2, and/or wells in the assay plate 4 for fluid extraction or dispensing actions.

The code reader 5 installed in the header 8 is configured to read labels on the surface of the sample tubes 1, the reagent tubes 36, the cartridges 2, and/or the assay plates 4.

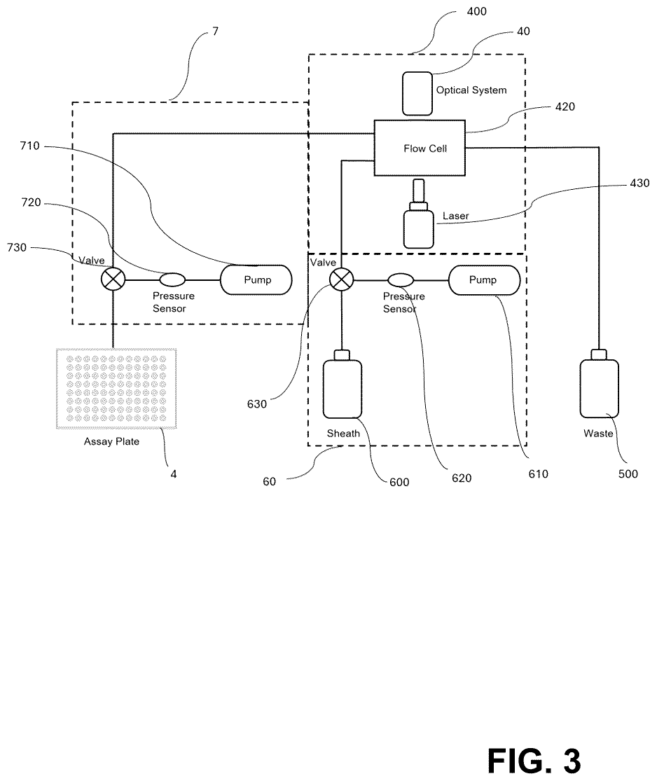

FIG. 3 illustrates a portion of the fluidic system 100 of an example flow cytometer 20. The sheath tank 600, which stores sheath fluid, is connected by tubes to the flow cell 420 of the sample analyzer 400 and the handler wash module 700. The waste tank 500 is connected by tubes to the sample analyzer 400 and the handler wash module 700, collecting the sheath fluid and waste material from the sample analyzer 400 and the handler wash module 700.

The sheath tank 600, waste tank 500, the handler wash module 700, and the probe 6 are each part of the instrument's fluidic system 100. The connecting structures and methods between these parts are considered common knowledge within this field, and may include pumps 610, 710; valves 630, 730; and pressure sensors 620, 720 as needed. The flow cytometer 20 also includes a processing unit 800, which serves as the central control unit configured to coordinate the operation of different components in the instrument 20. The processing unit 800 also converts signals from the optical detectors 410 of the analyzer 400 into electronic data and processes and analyzes the data. The data can be transferred to the software installed on an external computer 30 for analysis. The analyzed data is presented in the software user interface and can also be stored in the external computer 30 for further analysis. Users can communicate with the processing unit 800 through the software.

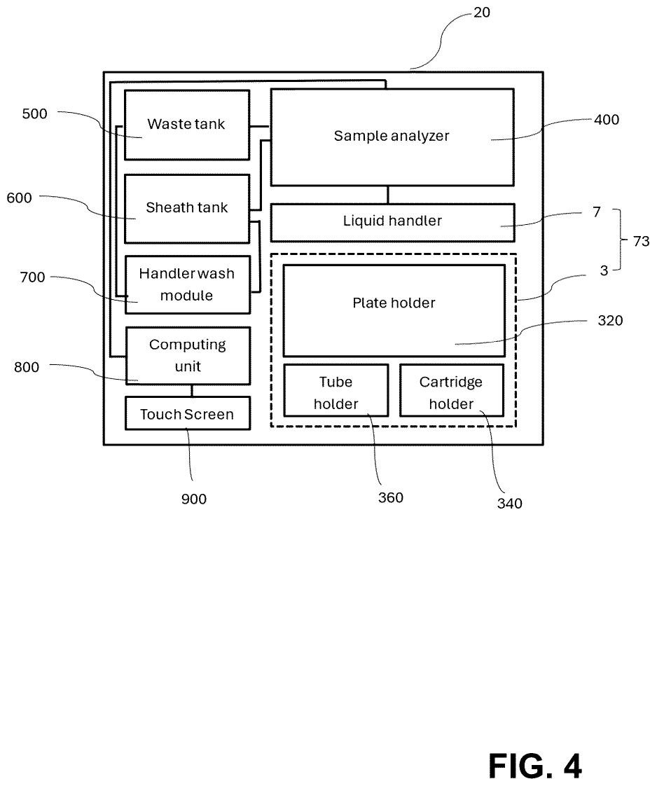

In other embodiments, shown representatively in FIG. 4, the flow cytometer 20 comprises an integrated computing unit 800 including a user interface 900 that facilitates communication between the user and the computing unit 800. The computing unit 800 includes a processor and a memory subsystem, serving as the instrument's computational and control center. The user interface 900 provides tools such as a touch screen, touchpad, mouse, and keyboard for users to interact with the instrument 20 and to display the analyzed data generated by the instrument 20.

### Multi-Well Assay Plate System for Enhanced Flow Cytometry and Method of Use

A multi-well assay plate system 200 for enhanced flow cytometry is provided. The multi-well assay plate system 200 is configured to interact with an information management system via labels (e.g., bar code, QR code) on the assay plates 4, sample tubes 1, reagent tubes 36, and cartridges 2. The reader in the sample preparation module is employed to scan these codes, facilitating the seamless transfer of information.

Each assay plate 4 includes a label that encodes information about an assay type associated with the specific solutions housed in the wells of the assay plate 4. Once the label is scanned by the reader, an assay protocol can be loaded (e.g., automatically loaded) from a local database or from the internet to the software/computing unit 800. The assay protocol can define a particular workflow to be performed with the assay plate 4 when preparing and analyzing a specimen sample; the workflow may include tasks such as sample dilution, adding buffer, incubation time, incubation temperature, incubation CO₂ level, incubation humidity level, and introducing labelled reagents (e.g., dyes). To execute the assay protocol, the processing unit 800 precisely manages the components, including the liquid handler 7, the handler wash module 700, the tray 3, and the pumps 610, 710, and valves 630, 730 of the fluidic system 100, etc.

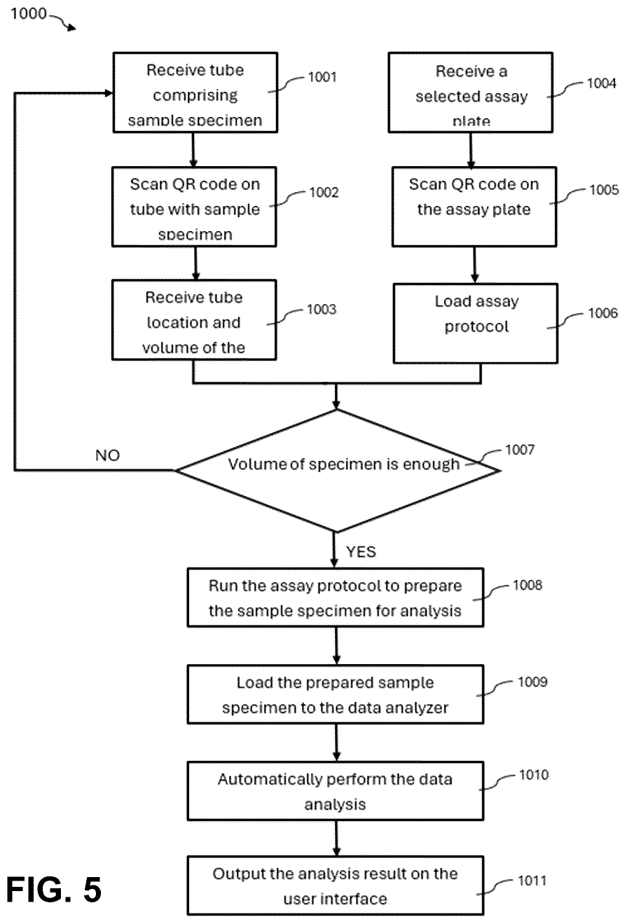

Referring now to FIG. 5, the present disclosure provides a method 1000 of using an assay plate 4 to prepare a sample specimen for flow cytometry analysis, for analyzing the prepared sample specimen via flow cytometry, and outputting the analysis results.

In step 1001, a tube 1 comprising a sample specimen is placed in the tube holder 360, and in step 1002 the reader reads the label on it in the sample preparation module of the multi-well assay plate system 20. The tube's location and the specimen's volume in the tube 1 are input by the user on the user interface in step 1003.

In step 1004, the user selects one assay plate 4 associated with a desired assay to be performed on the sample specimen. The user can place the chosen assay plate 4 in the plate holder 320 when or after the tube 1 with the sample specimen is placed in the tube holder 360. In some embodiments, step 1004 alternatively includes selecting a multi-well assay plate 4 from a rack configured to store a plurality of multi-well assay plates 4. After the label on the tube 1 with the sample specimen is scanned, the user can select the desired assay type on the user interface, and the system can find the corresponding assay plate in the storage based on the selection, scan the label on it (step 1005), and automatically load it to the plate holder 320 (step 1006).

After the selected assay plate 4 is placed in the plate holder 320 and the label on it is scanned (steps 1004-1006), the assay type associated with the assay plate 4 can be used for display on the user interface along with an associate link. Through this link, users can access and load the assay protocol into the software from either a local database or from the internet.

With the volume of the sample specimen input by the user and the assay protocol loaded in the computing unit/software, the computing unit/software computes (step 1007) if the volume of the input sample specimen is sufficient to perform the selected assay protocol. If the volume of the sample specimen is enough, the system proceeds to perform the assay on the sample specimen. The probe 6 of the liquid handler 7 dispenses a portion of the sample specimen to sample wells in the assay plate 4, and precisely transfers any required reagents from the preloaded wells to the sample wells. The flow cytometer then enables the reaction/incubation steps in the sample wells to occur (e.g., at the required incubation temperature, humidity, and CO₂ level) consistent with the assay protocol associated with the assay plate 4 (step 1008). If the volume is less than the assay protocol needs, a message appears on the user interface asking the user to add more sample in the tube 1 with the sample specimen or to add another tube 1 with an extra volume of the sample specimen. After the additional tube 1 is received, the tube's location and the specimen volume are input by the user, and the computing unit/software will do the computing step 1007 again.

After preparing the sample specimen for analysis (step 1008), the system introduces (e.g., automatically introduces) sample specimens and sheath fluid into the sample analyzer 400 (step 1009). The system draws both the sample specimen and the sheath fluid into their respective tubing through a precisely controlled mechanism, and then seamlessly integrates these fluids within the flow cell 420, allowing for the accurate and synchronized analysis of individual particles or cells as they pass through the laser beams and the emitted signal gets detected by the optical detectors 410.

As particles or cells pass through the laser beam generated by the laser 430, optical detectors 410 capture signals generated by the interaction between the particles and the laser light. These signals are then converted into electrical pulses, and the system processes the data to relevant information such as size, granularity, and fluorescence intensity (step 1010). Following data acquisition, the software analyzes the signals, classifying and quantifying individual particles based on predetermined parameters.

Ultimately, the system presents the analyzed results in a comprehensible format on the user interface (step 1011).

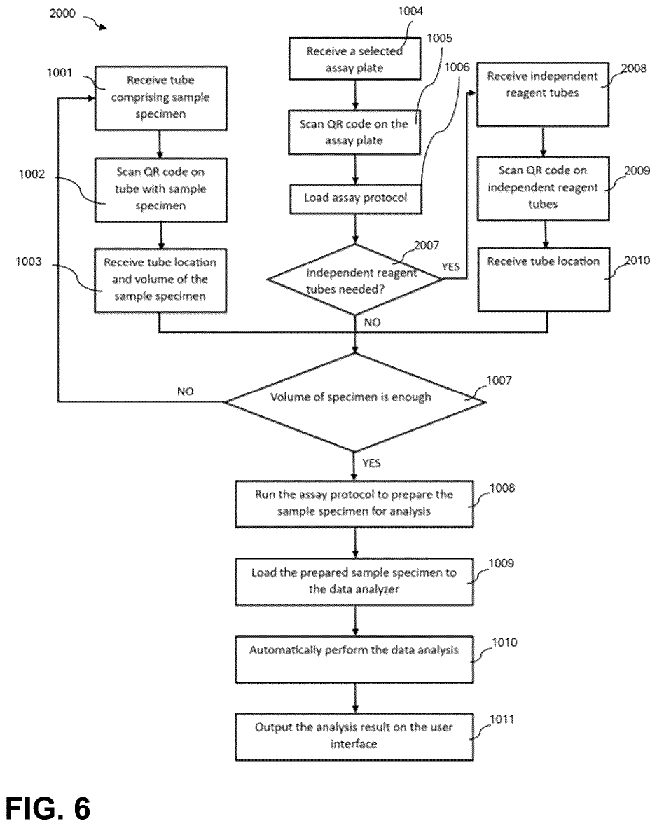

In some embodiments (FIG. 6), following the step 1006 that the assay protocol is loaded in the computing unit/the software, the computing unit/software determines whether additional reagents are required based on the selected assay protocol (step 2007). If additional reagents are required, a message is displayed on the user interface asking the user to place the additional independent reagent tubes in the tube holder. After the independent reagent tubes are placed in the tube holder (step 2008) and the labels on them are scanned (step 2009), users input the reagent tube locations on the user interface (step 2010). The system then runs the assay protocol to prepare the sample specimen for analysis (step 1008), loads the prepared sample specimen to the data analyzer 400 (step 1009), obtains data about the sample specimen from the data analyzer (step 1010), and outputs the analyzed data to the user interface (step 1011).

### Method of Maintaining the Multi-Well Assay Plate System and Preparing it for Assay

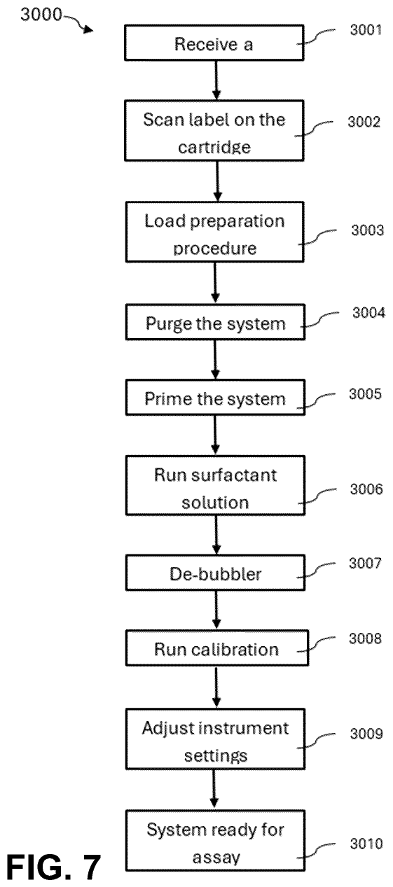

To ensure accurate and reliable test results, a method of preparing the multi-well assay plate system with a cartridge before performing an assay is also provided (FIG. 7).

A cartridge 2 that at least contains a cleaning solution, a disinfection solution, a surfactant, and a calibration bead suspension is placed in the cartridge holder 340 by a user (step 3001). In some embodiments, a cartridge 2 can be automatically placed in the cartridge holder 340 from a rack configured to store a plurality of cartridges 2 are stored is part of the system.

Upon scanning the label on the cartridge (step 3002), information about the cartridge 2, including for example the lot number, expiration date, and the stock volume of the cartridge contents, may be presented on the user interface. A procedure to prepare the system for the assay can be retrieved from the computing unit/software (step 3003), and the system's processing unit 800 can regulate the various components to execute the preparation procedure. The preparation procedure includes the steps below.

Purging the system (step 3004). The liquid handler 7 transfers all the solution from all the tubing to the waste container 500 to flush out any remaining sheath, sample, or reagent from the system.

Priming the system (step 3005). The processing unit controls the sheath injection from the sheath tank 600 into the sample injection part of the sample analyzer 400 through a coordinated operation of a pump 610 and valves 630. The sheath fluid runs through all the fluidic lines in the analyzer 400 to ensure that all the tubing is filled with sheath solution.

Running surfactant solution through the tubing of the sample analyzer (step 3006). the liquid handler 7 transfers the surfactant solution from the cartridge 2 to the sample analyzer 400 and runs the surfactant solution through the tubing to reduce the surface tension of the inside wall surface of the tubing. The lower surface tension facilitates smoother fluid flow and helps maintain consistent sheath fluid properties.

Debubbling (step 3007). This step involves running sheath fluid through the sample analyzer 400's tubing. The sheath fluid flow removes any air bubbles.

Running calibration beads suspension through the tubing of the sample analyzer (step 3008). The liquid handler 7 transfers the calibration beads suspension from the cartridge 2 to the sample injection port and through the tubing of the sample analyzer 400. The results are processed, recorded and optionally presented on the user interface.

After the results are presented on the user interface, the instrument 20 adjusts the operating parameters as needed, such as voltage or gains, based on the calibration protocol (step 3009).

Once all the steps in the preparation procedure are completed, the system is ready to perform assays (3010).

To maintain the instrument in good working condition, a shutdown procedure will be performed before the instrument shuts down after all the tests are done. The system runs the clean solution from the cartridge to remove any residual sample or debris and the disinfection solution from the cartridge to eliminate any potential biohazard.

### EXAMPLES

### Example 1

For a cell viability assay using the multi-well assay plate system, the reagents in a cartridge include:
Propidium Iodide (PI): A fluorescent dye that binds to DNA, used to identify dead cells. It only penetrates cells with compromised membranes.
Calcein AM: A non-fluorescent dye that is converted into a green-fluorescent calcein by live cells, indicating viable cells.
Phosphate-Buffered Saline (PBS): Used as a buffer to maintain pH and osmolarity.

To define the wells that will contain reagents and those designated for customer sample addition, consider a 96-well plate layout with rows labeled A to H and columns labeled 1to 12. Considering the volume limitations, each well is designed to efficiently mix reagents and samples within a volume range of 20 μl to 500 μl.
All wells in columns 1 and 2 are prefilled with viability dyes (Propidium Iodide and Calcein AM) and Phosphate-Buffered Saline (PBS). These serve as controls to ensure the dyes and assay conditions are functioning correctly.
The wells in columns 3 and 4 are prefilled with 100 μl PBS buffer in each well for negative control samples that the system can add.
The wells in columns 5 and 6 are prefilled with the cytotoxic agent and 100 μl

PBS buffer in each well for positive control samples that the system can add, the volume of the cytotoxic agent based on the agent's concentration to achieve the desired final concentration.
Wells from columns 7 to 12 across rows A to H are prefilled with 100 μl PBS buffer and are designated for customer samples. Here, the system will add the cell samples to be mixed with the prefilled reagents.

For a cell viability assay using a 96-well plate, incorporating both positive and negative controls is crucial for validating the assay results.

The layout for the controls and samples is defined:
Negative Controls: Wells A3, A4 and B3, B4 (duplicates) are filled with cells known to be viable, without the addition of any treatment that could affect viability.
Positive Controls: Wells A5, A6 and B5, B6 (duplicates) contain cells treated with a known cytotoxic agent to ensure they are non-viable.
Samples: Starting from wells A7-H12, arrange the customer samples in duplicates or triplicates. For example, wells C7, C8, and C9 could hold duplicate or triplicate samples from one experimental condition.

Before the experiment, the user is aware that they will be testing the cell viability of the sample. Therefore, they select an assay plate as the one above for testing cell viability. The user places the prepared tube containing the sample suspension in the tube holder of the system's tray. Additionally, they place the chosen assay plate in the plate holder of the system's tray. Once the tray returns to the sample preparation station, the system scans the QR code on the sample tube and on the assay plate and loads an assay protocol associated with that QR code on the assay plate into the system.

After receiving the location of each tube and the volume of the sample suspension, confirming that the volume of the sample suspension input is sufficient to complete the loaded assay protocol, the system executes the assay. Each step of the assay involves:
1. Sample Addition:
   Add 100 μl of the cell suspension to each sample well. The final volume in these wells is now 200 μl. For positive and negative controls, the cell suspension is also added to the PBS in the wells.
2. Staining:
   Add the viability dyes to all wells, including controls and samples. The volume of dye added should be calculated based on the optimal final concentration of the dye in the 200 μl final volume.
3. Incubation:
   Allow the plate to incubate at room temperature for 15-30 minutes, protected from light, for the dyes to stain the cells.
4. Flow Cytometry Analysis:
   After incubation, cells are transferred by the probe to the flow cell in the sample analyzer for analysis.
5. Flow Cytometry Analysis:
   Cells pass through the analyzer, where dyes emit fluorescence upon excitation.
6. Data Collection:
   The processing unit processes the fluorescence data to assess cell viability.

The processed fluorescence data will be present in a comprehensible format on the user interface.

### Example 2: Immunophenotyping Assay

For an immunophenotyping assay to detect and classify immune cell subsets such as T cells, B cells, and NK cells using surface marker antibodies, a 96-well plate with rows labeled A to H and columns labeled 1 to 12 for use with the multi-well assay plate system includes:
Columns 1 and 2: Prefilled with fluorophore-labeled antibodies such as FITC-CD4 and PE-CD8 for T-cell markers.
Columns 3 and 4: Prefilled with fluorophore-labeled antibodies for B-cell (e.g., APC-CD19) or NK-cell markers.
Columns 5 and 6: Reserved for isotype control antibodies to validate specificity.
Columns 7 to 12: Empty wells for custom experimental samples or additional antibody panels.

Eppendorf tubes contain user-defined secondary antibodies or wash buffers to complement preloaded reagents, and store fluorophore-conjugated markers for additional panels.

### Automation:

The liquid handler aspirates antibodies or buffers from the tubes and dispenses them into empty wells, streamlining panel customization and washing steps.

### Example 3: Apoptosis Assay

For an apoptosis assay to quantify apoptotic cells using Annexin V and viability dyes, a 96-well plate with rows labeled A to H and columns labeled 1 to 12 for use with the multi-well assay plate system includes:
Columns 1 and 2: Prefilled with Annexin V-FITC.
Columns 3 and 4: Prefilled with Propidium Iodide (PI).
Columns 5 and 6: Dual-stained wells with both Annexin V and PI.
Columns 7 to 12: Empty wells for user-defined apoptosis experiments.

Eppendorf tubes contain secondary reagents or novel apoptosis-inducing compounds, and provide calibration standards for fluorescence intensity.

### Automation:

The liquid handler handles reagent addition, incubation timing, and aspirates excess dye for improved consistency.

### Example 4: Cytokine Profiling

For a cytokine profiling assay to measure cytokine levels in cell culture supernatants or plasma, a 96-well plate with rows labeled A to H and columns labeled 1 to 12 for use with the multi-well assay plate system includes:
Columns 1 to 6: Prefilled with capture and detection antibodies for cytokines like IL-6, TNF-α, and IL-10.
Columns 7 to 12: Empty wells for custom cytokine panels or experimental controls.

Eppendorf tubes store cytokine standards for calibration curves, and provide additional detection reagents for expanded cytokine analysis.

### Automation:

The system dispenses standards into calibration wells and integrates washing steps using reagents from the tubes.

### Example 5: Drug Screening Assay

For a drug screening assay to evaluate the cytotoxic or therapeutic effects of drugs on culture cells, a 96-well plate with rows labeled A to H and columns labeled 1 to 12 for use with the multi-well assay plate system includes:
Columns 1 to 3: Prefilled with varying concentrations of test compounds.
Columns 4 to 6: Control wells with no drug (negative controls) or vehicle-only wells.
Columns 7 to 12: Empty wells for custom drug combinations or conditions.

Eppendorf tubes store experimental drug stocks or neutralizing agents for post-incubation reaction termination.

### Automation:

The liquid handler aspirates from tubes and dispenses precise volumes into specific wells, synchronizing compound addition and incubation timing.

1. A system for analyzing multiple samples by flow cytometry, the system comprising:
a sample preparation module comprising:
a tray configured to accommodate at least one tube containing a sample specimen and a multi-well assay plate,
a reader configured to capture an identifier code associated with the sample specimen, a sample analyzer configured to analyze sample disposed in the sample preparation module,
a liquid handler including at least one probe in fluid communication with the sample analyzer and configured to contact the sample specimen, and
a handler wash module configured to wash the probe before and/or after the probe contacts a sample; and
a processing unit in operative communication with the sample analyzer and configured to control the operation of the sample preparation module, the handler wash module, and the sample analyzer.

2. The system of claim 1, wherein the multi-well assay plate comprises the information identifier code.

3. The system of claim 2, wherein the information identifier is configured to provide information about an assay type to be performed on the sample specimen.

4. The system of claim 1 further comprising at least one reagent tube configured to house one or more flow cytometry reagents.

5. The system of claim 1, wherein the tray is configured to accommodate a cartridge including a clean solution, a disinfection solution, a surfactant solution and a calibration bead suspension, said wherein the probe is configured to transport the clean solution, the disinfection solution, the surfactant solution, and the calibration bead suspension from the cartridge.

6. The system of claim 1, wherein the tray comprises a tube holder, a cartridge holder, and an assay plate holder.

7. The system of claim 6, said tube holder can hold four tubes.

8. The system of claim 1, wherein the liquid handler further comprises a CCD camera configured to adjustably move closer to and farther from the tray.

9. The system of claim 1, wherein the sample preparation module includes a CO₂ regulation system and a humidity control system.

10. The system of claim 1, wherein the sample preparation module includes a temperature control system.

11. A method of analyzing multiple samples by flow cytometry, the method comprising:
receiving one tube containing sample specimen;
scanning a first label on said tube;
receiving a location and a volume associated with the sample specimen;
receiving a multi-well assay plate;
scanning a second label on said assay plate;
loading assay protocol instructions into a processor associated with a flow cytometer system;
determining, via the assay protocol instructions, if the volume of the sample specimen is sufficient;
analyzing, if the volume of the sample specimen is sufficient, the sample specimen according to the assay protocol instructions, wherein the analyzing comprises:
transferring a portion of the sample specimen to a sample analyzer of the flow cytometer;
collecting, via the flow cytometer, flow cytometry data associated with the portion of the sample specimen;
processing the flow cytometry data according to the assay protocol instructions; and
outputting the processed flow cytometry data to a user interface associated with the flow cytometer.

12. The method of claim 11, wherein the assay protocol instructions cause the flow cytometer to add one or more reagents to the sample specimen before the step of transferring the portion of the sample specimen to the sample analyzer of the flow cytometer.

13. The method of claim 12, wherein the step of adding one or more reagents comprises:
receiving one or more reagent tubes, each tube containing one reagent;
scanning a label on each of the one or more reagent tubes to obtain an identity of each reagent; and
receiving a location associated with each of the one or more reagent tubes.

14. A method of preparing a multi-well assay plate system of claim 1 for assay, comprising:
receive a cartridge;
scan the label on the cartridge;
load the preparation procedure to the software/computing unit;
purge the system with said clean solution;
prime the system with sheath fluid in the sheath tank of the system;
run said surfactant solution through the tubing of the system;
debubble the system with sheath fluid;
run calibration bead suspension through the tubing of the system;
adjust settings for the system according to the calibrated results.
